(19) United States
(12) Patent Application Publication
(10) Pub. No.: US 2006/0251177 A1
(43) Pub. Date: Nov. 9, 2006

(54) Error concealment and scene change detection

(76) Inventor: Jennifer L. H. Webb, Dallas, TX (US)

Correspondence Address: TEXAS INSTRUMENTS INCORPORATED, P O BOX 655474, M/S 3999, DALLAS, TX, 75265, US

(21) Appl. No.: 11/125,508

(22) Filed: May 9, 2005

(51) Int. Cl. H04B 1/66; H04N 11/04; H04N 11/02; H04N 7/12

(52) U.S. Cl. 375/240.27; 375/240.24; 375/240.12; 375/240.18

(57) ABSTRACT

A concealment method for a lost frame in decoding a video sequence which was compressed with block motion compensation and transform coefficient quantization compares high-frequency content of co-located macroblocks of frames immediately preceding and following a lost frame to decide whether a scene change has occurred and what concealment approach to pursue.

### BACKGROUND

The present invention relates to digital video signal processing, and more particularly to devices and methods with video compression.

Various applications for digital video communication and storage exist, and corresponding international standards have been and are continuing to be developed. Low bit rate communications, such as, video telephony and conferencing, led to the H.261 standard with bit rates as multiples of 64 kbps. Demand for even lower bit rates resulted in the H.263 standard.

H.264 is a recent video coding standard that makes use of several advanced video coding tools to provide better compression performance than existing video coding standards such as MPEG-2, MPEG-4, and H.263. At the core of the H.264 standard is the hybrid video coding technique of block motion compensation and transform coding as illustrated in FIG. 2b; MPEG and H.263 are similar but with the deblocking filter outside of the motion compensation loop as illustrated in FIG. 2a. Block motion compensation is used to remove temporal redundancy, whereas transform coding is used to remove spatial redundancy in the video sequence. Traditional block motion compensation schemes basically assume that objects in a scene undergo a displacement in the x- and y-directions. This simple assumption works out in a satisfactory fashion in most cases in practice, and thus block motion compensation has become the most widely used technique for temporal redundancy removal in video coding standards.

Block motion compensation methods typically decompose a picture into macroblocks where each macroblock contains four 8×8 luminance blocks plus two 8×8 chrominance blocks, although other block sizes, such as 4×4, are used in H.264. The transform of a block, typically a two-dimensional discrete cosine transform (DCT) or an integer transform, convert the pixel values of a block into a spatial frequency domain for quantization; this takes advantage of decorrelation and energy compaction of the transform. For example, in MPEG and H.263 the 8×8 blocks of DCT-coefficients are quantized, scanned into a one-dimensional sequence, and coded by using variable length coding (VLC). For predictive coding using block motion compensation, inverse-quantization and IDCT are needed for the feedback loop. Except for the motion compensation, all the function blocks in FIG. 2a operate on an 8×8 block basis. The rate-control unit in FIG. 2a is responsible for generating the quantization step (qp) in an allowed range and according to the target bit-rate and buffer-fullness to control the DCT-coefficients quantization unit. Indeed, a larger quantization step implies more vanishing and/or smaller quantized coefficients which means fewer and/or shorter codewords and consequent smaller bit rates and files.

There are two kinds of coded macroblocks. An Intra-coded macroblock is coded independently of previous reference frames. In an Inter-coded macroblock, the motion compensated prediction block from the previous reference frame is first generated for each block (of the current macroblock), then the prediction error block (i.e. the difference block between current block and the prediction block) are encoded.

The first (0,0) coefficient in an Intra-coded 8×8 DCT block is called the DC coefficient, the rest of 63 DCT-coefficients in the block are AC coefficients; while for Inter-coded macroblocks, all 64 DCT-coefficients are treated as AC coefficients. The DC coefficients may be quantized with a fixed value of the quantization step, whereas the AC coefficients have quantization steps adjusted according to the bit rate control which compares bit used so far in the encoding of a picture to the allocated number of bits to be used. Further, a quantization matrix (e.g., as in MPEG-4) allows for varying quantization steps among the DCT coefficients.

When decoding digital video that may be corrupted, a robust decoder must detect errors and continue decoding by skipping to the next available start code or resynchronization marker. Because motion vectors may be used to copy content from a previous frame to the current frame, errors tend to propagate from frame to frame. To improve visual quality and limit error propagation, a decoder typically performs some sort of error concealment to fill in the pixels corresponding to the corrupted data that was skipped. Spatial concealment techniques use surrounding pixels to estimate the missing pixels. Temporal concealment techniques use pixels from the previous frame to estimate the missing pixels. Some frequency-domain techniques have also been proposed that estimate missing DCT coefficients based on neighboring DCT coefficients. Temporal concealment is highly effective for inter-coded data, when motion is smooth and frames are highly correlated. Spatial concealment is useful for intra-coded data, such as for a scene change, when there is no correlation with the previous frame.

Some error-resilience tools are provided by as a part of the syntax for MPEG-4 SP. Resync markers are used to divide the bitstream into independently decodable packets. Also, data partitioning is an option that puts the most important information, such as coding mode or motion vectors, into the first partition, so that this information may be used for concealment, even if the second partition is corrupted with errors. Another technique is adaptive intra refresh (AIR), which intra-codes macroblocks in areas of motion to limit error propagation. These tools are encoder options to provide recovery hooks in the bitstream for the decoder.

The latest video coding standards have more information available for error concealment. For instance, multiple reference frames are supported for motion compensation. In this case, multiple previous frames are stored by the decoder and may be used for error concealment. The H.264 standard supports Supplemental Enhancement Information (SEI) messages, including Spare picture SEI, and Scene information SEI. The Spare picture SEI gives an alternate for motion compensation if the normal reference data was lost due to corruption. The Scene information SEI can also help with concealment, indicating whether there is a scene transition. This additional information can improve the quality of error concealment. However, this information may not be provided, and is not available for previous video standards, such as H.263 or MPEG-4 SP.

Furthermore, the decision whether to use temporal or spatial concealment depends on whether there is a scene change or not. In some cases, the decoder may know whether a frame or macroblock was coded in intra mode, but that does not necessarily indicate a scene change. At the macroblock level, intra coding could indicate a new object in the scene, or the intra coding could be for AIR, or for mandatory H.263 refresh. At the frame level, an I-frame could be a scene change, or it could be a periodic I-frame provided to enable random access. If the Intra frame is not for a scene change, temporal concealment will usually give the best quality, but if it is for a scene change, temporal concealment will give poor quality.

Typically, error concealment is performed after error detection and before decoding of subsequent frames. No information from subsequent frames is used for error concealment. Scene change information is not extracted from available information for error concealment, although newer standards support sending side information about scene changes to aid error concealment.

Lee et al, Fast Scene Change Detection using Direct Feature Extraction from MPEG Compressed Videos, 2 IEEE Tran. Multimedia 240 (2000) detects scene changes by comparison of edges and directions extracted from consecutive frames, both I-frames and, with approximate reconstruction, P-frames and B-frames. The scene changes are used for video segmentation to allow intelligent video storage and management.

### SUMMARY OF THE INVENTION

The present invention provides video decoding error concealment mode decision for a lost frame/macroblock by comparing estimated edge content of a following frame with that of a preceding frame. This also provides a method for detection of scene changes.

### BRIEF DESCRIPTION OF THE DRAWINGS

FIGS. 1a-1d show flow diagrams and examples of the computations.

FIGS. 2a-2c illustrate video coding functional blocks.

FIGS. 3a-5c show experimental results.

### DESCRIPTION OF THE PREFERRED EMBODIMENTS

1. Overview

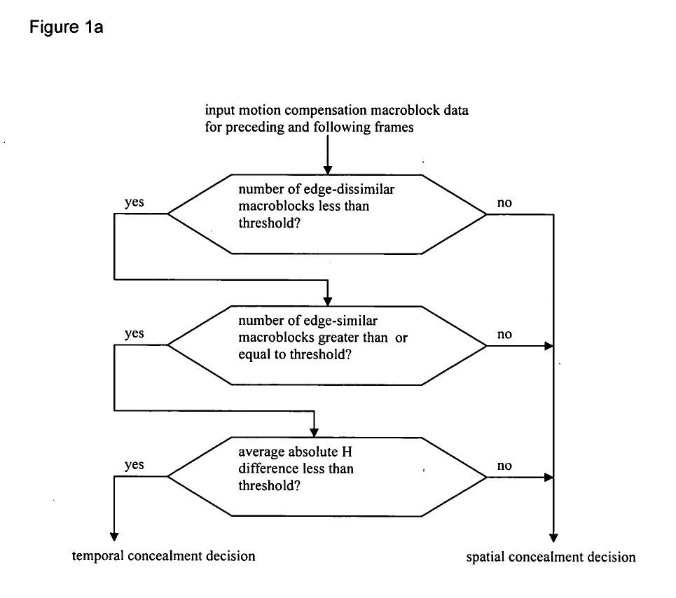

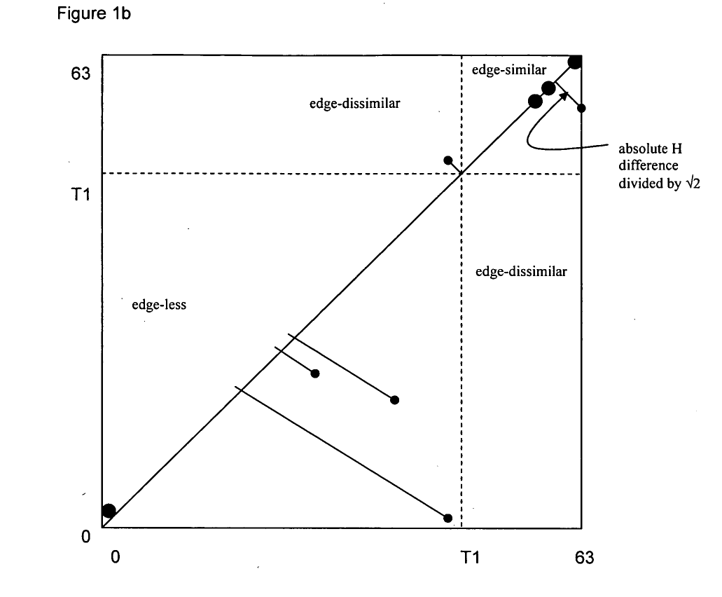

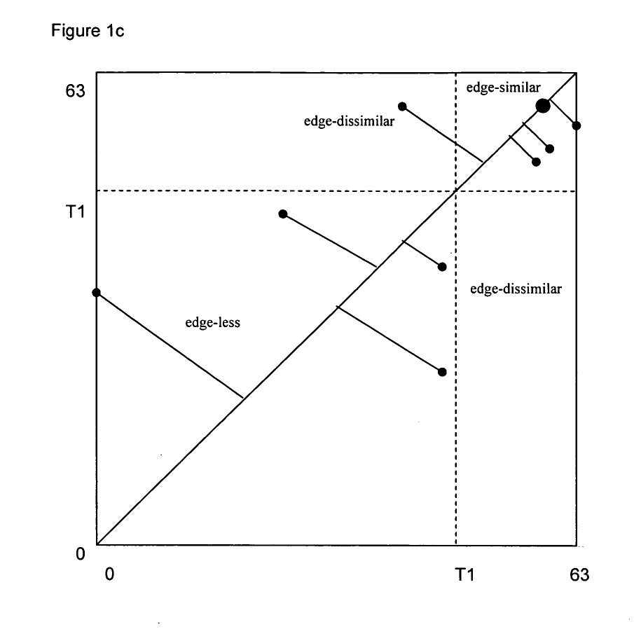

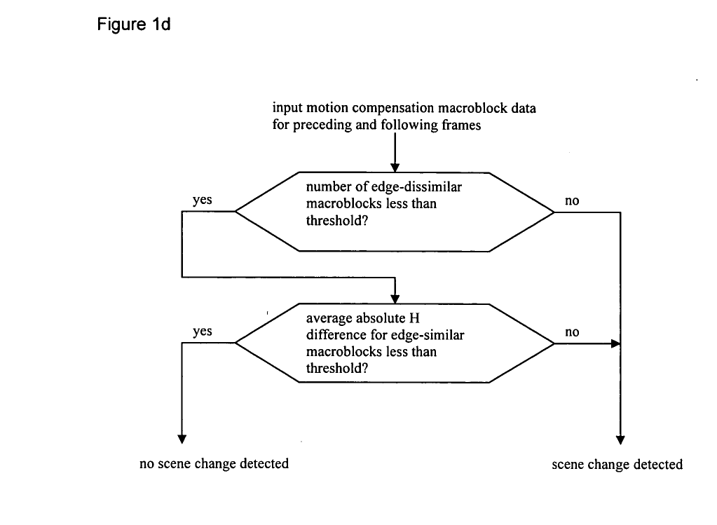

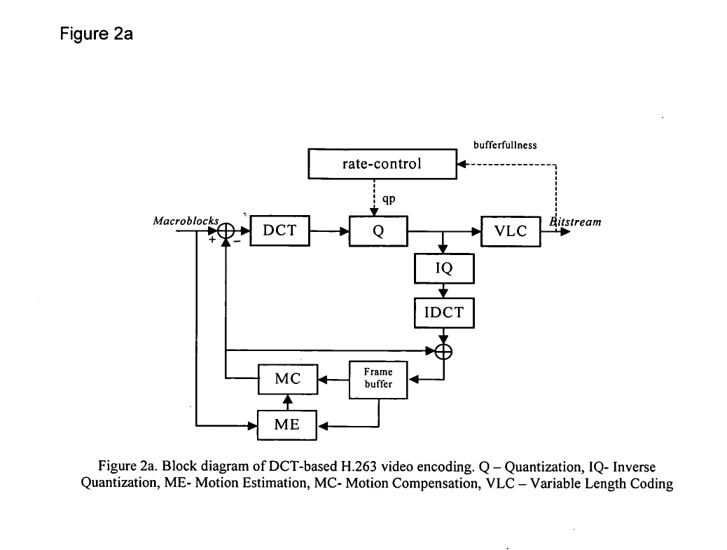

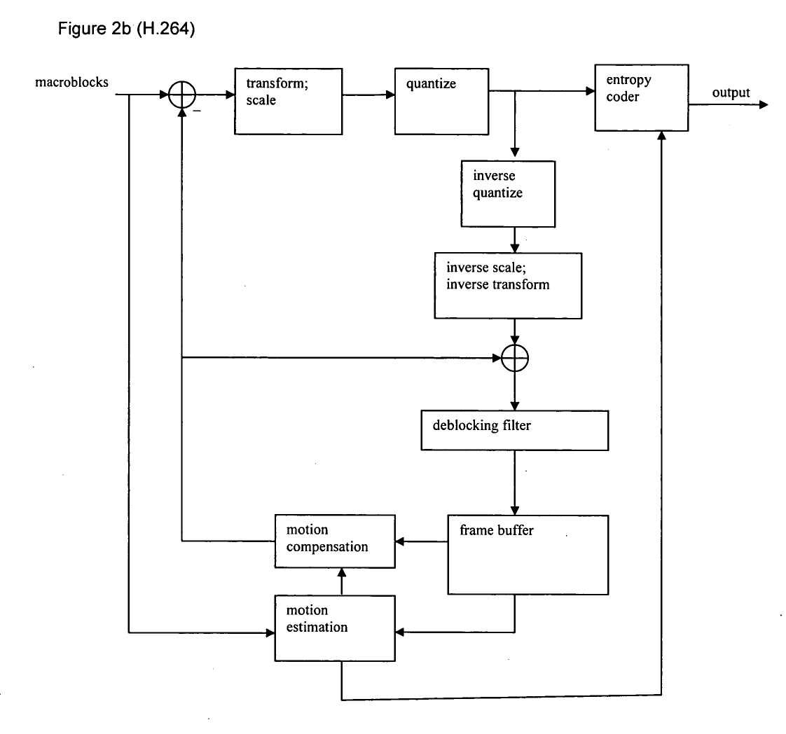

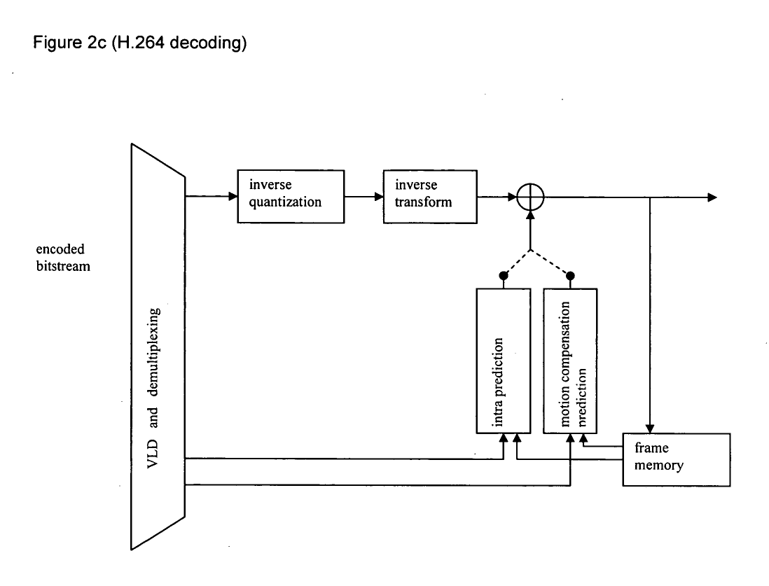

Preferred embodiment methods use information from the frame following an error detection to determine what kind of concealment should be performed. Even though this following frame cannot be fully reconstructed without a reference frame, preferred embodiment methods use a comparison of grey reconstructions or, more simply, luminance texture comparison to determine whether a scene change likely occurred at the error-lost frame, and to determine the preferred type of concealment. These methods are particularly useful if an I-frame is lost due to error corruption. The method could also be applied to conceal intra-coded macroblocks that are corrupted. Of course, this also provides scene change detection by treating an I-frame as a lost frame; see FIGS. 1a and 1d.

Preferred embodiment systems perform preferred embodiment methods with any of several types of hardware: digital signal processors (DSPs), general purpose programmable processors, application specific circuits, or systems on a chip (SoC) such as combinations of a DSP and a RISC processor together with various specialized programmable accelerators such as for FFTs and variable length coding (VLC). A stored program in an onboard or external (flash EEP) ROM or FRAM could implement the signal processing. Analog-to-digital converters and digital-to-analog converters can provide coupling to the real world, modulators and demodulators (plus antennas for air interfaces) can provide coupling for transmission waveforms, and packetizers can provide formats for transmission over networks such as the Internet.

2. Concealment Preferred Embodiments

When the first intra-frame of a sequence is lost, the first preferred embodiment decoder substitutes a solid grey frame, because there is no a priori knowledge of the data. Then when the second frame is reconstructed with this grey reference frame, the decoder is able to detect any moving edges and any macroblocks that are intra coded. Over time, more and more of the scene develops.

If an intra-frame for a scene change is lost, the decoder can similarly recover the new scene from a solid grey frame, but if the decoder tries to use the old scene (prior to the lost intra-frame) for the reference frame, the result will be two superimposed scenes, which will obscure the new scene.

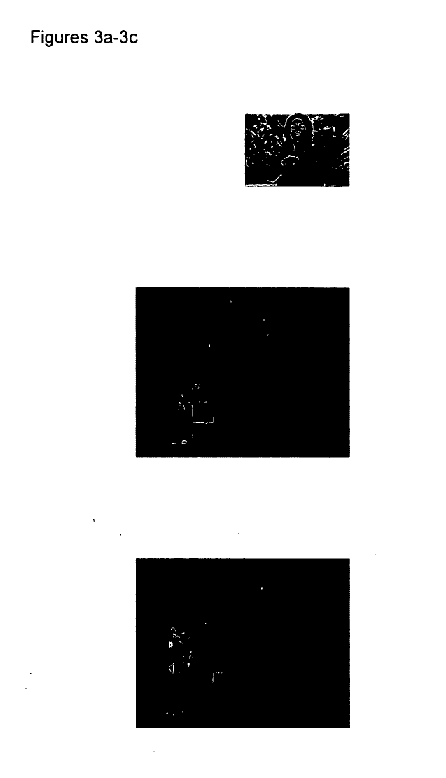

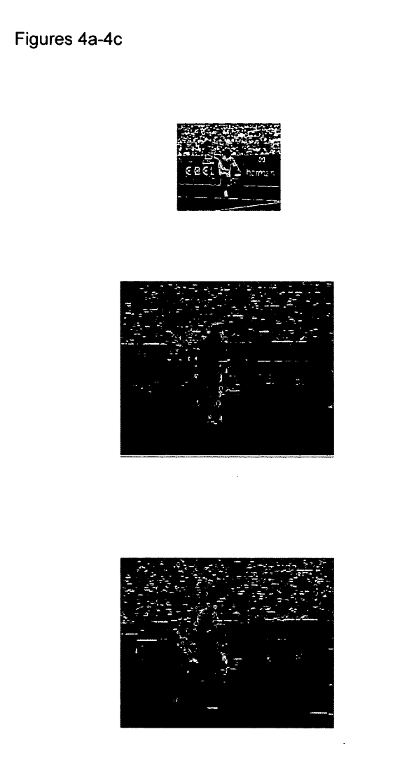

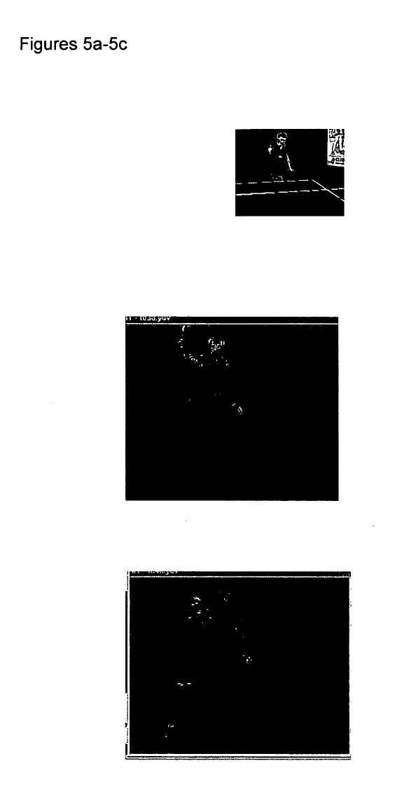

To determine whether a lost I-frame was a scene change, the first preferred embodiment compares the data from the frames before and after the lost frame, applying the data to a grey reference frame. FIGS. 3a (“Silent”), 4a (“Stefan”), and 5a (“Tennis”) show three different scenes, and FIGS. 3b-3c, 4b-4c, and 5b-5c show the “grey reconstruction” for two frames from each of the sequences. If the grey reconstruction from the following frame shows that there is no scene change, then temporal concealment may be used effectively. If the grey reconstruction of the following frame shows a scene change, then temporal concealment should be avoided, and the grey reconstruction may be a better alternative.

To see if two frames belong to the same scene, one possible metric is to compute the correlation coefficient between the two-dimensional grey reconstructions and compare to a correlation threshold to determine whether a scene change has occurred. However, computation of a correlation coefficient between images is computationally complex.

Scene detection methods that operate on images may be applied to the grey reconstruction. As noted in the background, some scene detection methods exist that operate on a compressed bitstream. These methods were developed in the context of video indexing for MPEG-7. Either may possibly be applied to aid preferred embodiment error concealment.

However, further preferred embodiments employ a simple method for scene detection and analyze the zigzag-order position of the last coded coefficient for each luminance 8×8 block, because this is a measure of the level of detail. The position of the last coded coefficient is calculated as the sum of the number of coefficients coded and the sum of the run-length values. A value of zero indicates no coefficients coded. Note that this data can be obtained by parsing the bitstream, without fully performing the grey reconstruction. For illustration, Table 1 shows the statistics for the column of macroblocks at the center of the frame (sixth column for QCIF format which is 11×9 macroblocks) for the frames used to generate FIGS. 3b-3c, 4b-4c, and 5b-5c.

TABLE 1
Position of the last coded luminance coefficient for 8 × 8
blocks in sixth column of frames. The frames were chosen
arbitrarily toward the middle of the bitstreams.

| Silent | | | | Stefan | | | | Tennis | | | |
|---|---|---|---|---|---|---|---|---|---|---|---|
| Frame 56 | | Frame 58 | | Frame 16 | | Frame 18 | | Frame 38 | | Frame 40 | |
| 3 | 0 | 0 | 4 | 51 | 50 | 61 | 59 | 0 | 0 | 0 | 2 |
| 51 | 48 | 51 | 55 | 64 | 46 | 59 | 63 | 61 | 43 | 61 | 0 |
| 47 | 34 | 47 | 51 | 58 | 60 | 63 | 61 | 40 | 2 | 13 | 0 |
| 52 | 52 | 23 | 59 | 14 | 57 | 60 | 62 | 64 | 1 | 64 | 0 |
| 55 | 53 | 56 | 40 | 40 | 52 | 63 | 64 | 60 | 0 | 64 | 0 |
| 57 | 8 | 56 | 25 | 63 | 61 | 56 | 64 | 45 | 0 | 41 | 0 |
| 25 | 35 | 25 | 9 | 64 | 58 | 63 | 49 | 32 | 0 | 51 | 43 |
| 40 | 47 | 27 | 16 | 63 | 59 | 56 | 51 | 49 | 0 | 47 | 54 |
| 39 | 34 | 18 | 57 | 63 | 63 | 64 | 60 | 37 | 62 | 44 | 62 |
| 61 | 56 | 62 | 56 | 61 | 18 | 56 | 59 | 29 | 24 | 33 | 17 |
| 57 | 1 | 56 | 59 | 52 | 21 | 55 | 55 | 42 | 0 | 19 | 11 |
| 46 | 10 | 61 | 44 | 60 | 63 | 64 | 63 | 0 | 2 | 0 | 1 |
| 52 | 27 | 31 | 34 | 57 | 53 | 57 | 22 | 23 | 49 | 0 | 0 |
| 33 | 13 | 39 | 24 | 62 | 48 | 63 | 14 | 4 | 30 | 0 | 0 |
| 31 | 46 | 0 | 47 | 28 | 0 | 61 | 0 | 2 | 28 | 0 | 22 |
| 48 | 47 | 46 | 47 | 22 | 34 | 36 | 37 | 0 | 22 | 0 | 0 |
| 13 | 0 | 20 | 34 | 0 | 0 | 0 | 0 | 0 | 0 | 0 | 0 |
| 23 | 0 | 23 | 6 | 13 | 35 | 37 | 35 | 0 | 0 | 0 | 0 |

Significant edges correspond to high-frequency coefficients, particularly positions above 50, for example. However, having no coefficients coded gives no information, since no edges are shown. One frame might have an edge due to slight motion, but if the motion stops, there may be no edge two frames later. Also, if there is a shift in position, the edge may move from one 8×8 block to another. Therefore, refine the data in Table 1 by selecting the highest position among the four 8×8 blocks in a 16×16 macroblock, as shown in Table 2.

TABLE 2
Zigzag position of highest-frequency coded coefficient in the
macroblock. This example shows data from the sixth column of
macroblocks. Shaded numbers are below 50 and denote low edge content.

| Silent | | stefan | | tennis | |
|---|---|---|---|---|---|
| Frane 56 | Frame 58 | Frame 16 | Frame 18 | Frame 38 | Frame 40 |
| 51 | 55 | 64 | 63 | 61 | 61 |
| 52 | 59 | 60 | 63 | 64 | 64 |
| 57 | 56 | 63 | 64 | 60 | 64 |
| 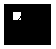 | 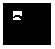 | 64 | 63 | 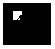 | 51 |
| 61 | 62 | 63 | 64 | 62 | 62 |
| 57 | 61 | 63 | 64 | 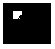 | 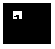 |
| 52 | 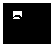 | 62 | 63 | 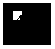 | 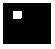 |
| 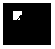 | 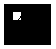 | 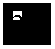 | 61 | 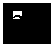 | 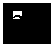 |
| 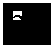 | 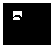 | 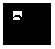 | 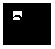 | 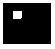 | 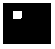 |

In general, without a scene change, some macroblocks in the frame may not match, due to motion or intra refreshing. If there is enough mismatch, treat it as a scene change for concealment purposes, even if the same objects are in the scene. The preferred embodiment identifies a scene match based on similarities that occur in the same region. Using the data in Table 2, measure how many of the macroblocks have similar edge content as follows. Let H (for high) denote the data in table 2. Then H1 is edge-similar to H2 if both H1>50 and H2>50. Among similar macroblocks, compute the average absolute difference.

Also measure the mismatch. Let H1 be called edge-dissimilar to H2 if H1>50 and H2≦50 or if H1≦50 and H2>50. In Table 2, macroblocks indicated with different shading are edge-dissimilar. Table 3 summarizes the edge-similarity and edge-dissimilarity for this example, based on these metrics.

TABLE 3
Each entry is: number of edge-similar macroblocks (average absolute
difference of H) and [number of edge-dissimilar macroblocks]. Shaded entries
have the minimum average absolute difference.

| | Silent56 | Silent 58 | Stefan16 | SZtefan18 | Tennis38 | Tennis40 |
|---|---|---|---|---|---|---|
| Silent56 | 6 (0) | 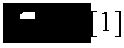 | 6 (7.5)[1] | 6 (8.5)[2] | 4 (6.5)[2] | 4 (7.5)[3] |
| Silent58 | 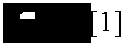 | 5 (0) | 5 (4) [2] | 5 (5) [3] | 4 (5) [1] | 4 (4.8)[2] |
| Stefan16 | 6 (7.5)[1] | 5 (4)[2] | 7 (0) | 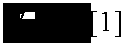 | 4 (2.8)[3] | 5 (4.4)[2] |
| Stefan18 | 6 (8.5)[2] | 5 (5)[3] | 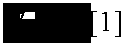 | 8 (0) | 4 (2.3) [4] | 5 (3.4)[3] |
| Tennis38 | 4 (6.5)[2] | 4 (5)[1] | 4 (2.8)[3] | 4 (2.3)[4] | 4 (0) | 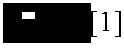 |
| Tennis40 | 4 (7.5)[3] | 4 (4.8)[2] | 5 (4.4)[4] | 5 (3.4)[3] | 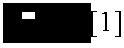 | 5 (0) |

For the example in Table 3, the preferred embodiment method selects temporal concealment based on average absolute difference of H for edge-similar macroblocks (shaded entries), while detecting a scene change if the number of edge-dissimilar macroblocks is too high (highlighted entries). More separation in the statistics would be expected if the entire frame were analyzed, rather than just one column of macroblocks.

In summary, the scene match detection method includes the following steps for the grey reconstructions of the frames immediately preceding and immediately following a lost frame:

(a) Compute H (e.g., Table 2) for each 16×16 macroblock; H is the largest zigzag position of any coded (non-zero quantized) luminance transform (e.g., DCT) coefficient in the four 8×8 blocks comprising the macroblock.

(b) Each macroblock is classified as having edge content if H is greater than T1 or not having edge content if H is less than or equal to T1. T1 may depend on the target bit rate or quantization parameter, QP. Because a high QP value results in fewer nonzero quantized transform coefficients, the position of the highest-frequency coded coefficient depends, to some extent, upon QP which is set by the rate control. T1 about 50 works for moderate QP values. Of course, for smaller transform blocks, such as 4×4 transforms in H.264, T1 would be much smaller, such as 12.

(c) Compute: the number of edge-similar macroblocks, the number of edge-dissimilar macroblocks, and the average absolute difference for edge-similar macroblocks.

(d) Decide the grey reconstructions have a scene match (temporal concealment for the lost frame) if all three of the following conditions are met:

(1) The number of edge-dissimilar macroblocks is less than T2. T2 depends on the total number of macroblocks in the frame; a simple choice could be T2=0.2 N where N is the number of macroblocks.

(2) The number of edge-similar macroblocks is greater than T3. T3 depends on the total number of macroblocks; again, a simple choice could be T3=0.4 N.

(3) The average absolute H difference for edge-similar macroblocks is less than T4. The data of Table 3 suggest a T4 in the range 3.5-4.0. An alternative metric is root-mean-square H difference.

Thus for QCIF frames (N=99 macroblocks) with a MPEG-4 quantization parameter QP≈8, a first preferred embodiment could use T1≈50, T2≈20, T3≈40, and T4≈3.75. FIG. 1a illustrates the steps of the method.

An alternative method omits condition (2) above; this defaults to temporal concealment when the edge content is low. Other variations are possible.

As an explicit illustration of the workings of the method which uses Table 3 data, presume three successive frames. F1, F2, F3, with F1 equal to frame 16 from “Stefan”, F2 lost, and F3 initially equal to frame 58 of “Silent”. First, compute the threshold comparisons and make the decision on scene change. Next, repeat the method but with F3 now equal to frame 18 of “Stefan”, and then another repeat of the method but with F3 equal to frame 38 of “Tennis”.

First, for the case of F3 equal to frame 58 of “Silent”, the 9 macroblock pairs for the sixth columns are classified as: 5 pairs are edge-similar with both Hs greater than 50 (=T1), 2 pairs are edge-dissimilar with one H greater than 50 and the other H less than or equal to 50, and 2 pairs are edge-less with both Hs less than or equal to 50. And the average H difference for the 5 edge-similar macroblocks is 4.0. Thus the method compares the data to the thresholds as follows:

The number of edge-dissimilar macroblocks equals 2 and is compared to T2. If T2=0.2 N, then T2=1.8 because N=9; and the first condition for a scene match is not met.

The number of pairs of edge-similar macroblocks equals 5 and is compared to T3. If T3=0.4 N, then T3=3.6 and the second condition for a scene match is met.

The average absolute H difference for the edge-similar pairs equals 4.0 and this is compared to T4=3.75, so the third condition for scene match is not met.

Thus the decision would be a scene change (i.e., from “Stefan” to “Silent”), and temporal concealment would not be used. Note that the second condition for a scene match was met, so the alternative method of omitting the second condition makes no difference in this case. Indeed, the number of edge-dissimilar pairs of macroblocks was the effective decision statistic; the average absolute H difference was close to the threshold for the third condition.

For the second case with F3 equal to frame 18 of “Stefan”, the number of edge-dissimilar pairs is 1, and the first condition for scene match is met. The number of edge-similar pairs is 7 with an average absolute H difference of 1.3, so the second and third conditions for scene match are easily met (i.e., from “Stefan” to more “Stefan”); and temporal concealment would be used.

For the third case with F3 equal to frame 38 of “Tennis”, the number of edge-dissimilar pairs is 3, and so the first condition for scene match is not met (i.e., a change from “Stefan” to “Tennis”). In contrast, the number of edge-similar pairs is 4 with an average absolute H difference of 2.3, so the second and third conditions for scene match are met; but temporal concealment would not be used. Again, the number of edge-dissimilar pairs was the significant decision statistic.

FIGS. 1b-1c shows graphically the classification of pairs of macroblocks and absolute H difference for two other examples from the table data. In particular, the pairs of co-located macroblocks of two frame are plotted according to H values: the horizontal axis indicates the H value of a macroblock in one frame and the vertical axis indicates the H value of the corresponding macroblock in the second frame. The broken lines represent the T1 value (about 50 in FIGS. 1b-1c) which defines high edge content, so edge-similar pairs appear as points in the upper right-hand small square and the distance to the main diagonal is the absolute H difference scaled by 1/√2. The edge dissimilar pairs appear as points in the upper and right rectangles; and points in the lower left large square represent a lack of edges in both macroblocks. The data for “Tennis” frames 38 and 40 is plotted in FIG. 1b with distances to the main diagonal shown for all off-diagonal points; note that the two H values are the same for 4 of the 9 pairs of macroblocks which thus are represented by points on the main diagonal. FIG. 1c plots the data for “Tennis” frame 38 with “Silent” frame 58. The clustering of points near or on the main diagonal for high H values indicates a scene match, so various geometrical measures could be used to define the thresholds for a decision statistic.

3. Scene Change Preferred Embodiments

The error concealment preferred embodiments can be adapted to scene change detection at an intra-coded frame by simply treating the intra-coded frame as the lost frame of the preceding section. For example, the number of edge-dissimilar macroblocks together with the average absolute H differences for edge-similar macroblocks provides low-complexity detection methods; see FIG. 1d. This detection method is analogous to the alternative method described in the preceding section which omits condition (2).

What is claimed is:

1. A method of error concealment in a block-motion-compensated video sequence, comprising:
(a) reconstructing a first frame from a grey reference frame and a first encoded frame;
(b) reconstructing a second frame from a grey reference frame and a second encoded frame, wherein said first encoded frame precedes an error frame and said frame follows said error frame;
(c) comparing said first frame and said second frame; and
(d) deciding upon error concealment for said error frame according to the results of step (c).

2. A method of error concealment in a block-motion-compensated with transform video sequence, comprising:
(a) comparing transform coefficients of blocks of a first encoded frame with transform coefficients of corresponding blocks of a second encoded frame, wherein said first encoded frame precedes an error frame and said second encoded frame follows said error frame;
(b) deciding upon error concealment for said error frame according to the results said comparing of step (a).

3. A method of scene change detection in a block-motion-compensated with transform video sequence, comprising:
(a) comparing high frequency transform coefficients of blocks of a first encoded frame with high frequency transform coefficients of corresponding blocks of a second encoded frame, wherein said first encoded frame precedes an intra-coded frame and said second encoded frame follows said intra-coded frame;
(b) detecting a scene change at said intra-coded frame according to the results said comparing of step (a).
